(19) United States
(12) Patent Application Publication
(10) Pub. No.: US 2004/0265448 A1
(43) Pub. Date: Dec. 30, 2004

(54) Method for aging wine

(76) Inventors: Yen-Kuen Shiau, Taipei (TW); Chung-Hsun Wu, Tao Yuan (TW)

Correspondence Address: Alice L. Chen, 3013 Birchtree Lane, Silver Spring, MD, 20906, US

(21) Appl. No.: 10/899,519

(22) Filed: Jul. 27, 2004

Related U.S. Application Data
(62) Division of application No. 09/918,453, filed on Aug. 1, 2001.

(51) Int. Cl. A23B 4/00

(52) U.S. Cl. 426/397

(57) ABSTRACT

An accelerated wine aging process comprises wrapping a container of wine with a substrate coated with spinel, AB 2O4, said spinel irradiates an electromagnetic wave length 3-30 micron. A preferred embodiment is to subject the container to the radiation of the spinel, wherein B component of the spinel AB2O4, contains at least 30% of iron.

### BACKGROUND OF THE INVENTION

1. Field of the Invention

This invention relates to a novel method of and a product for aging wine. More particularly, the aging of wine is accelerated by a far-infrared radiation emitting spinel. The method is to subject the wine container to the radiation of a spinel in the far-infrared range of wavelength.

It is well known that wine quality improves with aging. Some red table wines such as port requires aging for up to 10-20 years. White wine benefits by aging, stabilizing and clarification, as undesirable substances are precipitated. The traditional aging process is not only time-consuming, but also costly because storage space is required for the wine being aged, and the bottles have to be turned periodically to achieve uniform aging of the wine

Now, a new method has been found wherein a compound, spinel, having the general formula AB2O4, provides far-infrared radiation in the wave length range of 3-30 microns.

2. Prior Art

The compound spinel is known for its antimicrobial property as shown in Applicant's U.S. Pat. No. 6,051,246. U.S. Pat. No. 5,707,911 shows a screen of bi-layer ceramic coating which are heated to 180-300 degrees Centigrade. The wine is said to be aged by this radiation in two minutes. This method is complicated and cumbersome requiring elaborate ceramic compositions, and heating the ceramic coating before application to the bottle.

There is a long-sought need for a simple and economical method of accelerating the aging of wine. The object of this invention is to provide such a method. This method enables the winery to age the wine speedily and economically with uniformly good quality.

### SUMMARY OF THE INVENTION

Surprisingly, it has been discovered that spinel having the general formula AB2O4, wherein A is magnesium, divalent iron, nickel, manganese, cobalt, or zinc; B is aluminum, trivalent iron, trivalent manganese, or trivalent chromium, and O is oxygen, has the ability to age wine rapidly. This spinel emits electromagnetic radiation with a wavelength range of 3-30 microns, which ages wine much faster than in the absence of radiation.

It is found that the composition of the spinel controls the wavelength of the radiation. The B component of the spinel must be adjusted to contain at least 30% of iron to emit radiation with a wave length range of 18-30 microns. This ages wine in about thirty minutes. As the result of aging, wine acidity is reduced by forming esters.

### DETAILED DESCRIPTION OF THE INVENTION.

Spinel AB2O4, by virtue of its molecular structure, is capable of absorbing a broad spectrum of environmental energy and emitting radiation having a defined range of wave lengths. It has unexpectedly been found that far-infrared radiation can age wine rapidly. In accordance with this invention, the spinel emits radiation having wave lengths from of 3-30 microns, preferably 18-30 microns, for aging wine.

The spinel is ground into fine particles and mixed with epoxy resin in the ratio of 1:3 by weight and then coated on a substrate, such as plastic film to a thin layer, or the mixture can be coated directly onto a container as a coating or as a film (herein-after collectively referred to as wrapper). It is then wrapped around or coated on the wine container including wine pipeline. The container may be a bottle, jug or wine pipeline for bottling wine in the winery. It is immaterial how the wrapper is placed so long as the container is surrounded by spinel radiation. In the case of aging wine in a winery, the flow rate of wine in a pipeline may be adjusted to the time required for aging wine. The wine aged according to this process has improved quality as shown in the following experiments. Wine quality can only be assessed by human tasting.

Conventional wine aging takes at least two years for table wine. The new method in accordance with this invention uses spinel having the general formula AB2O4, wherein A is magnesium, divalent iron, nickel, manganese, cobalt, or zinc; B is aluminum, trivalent iron, trivalent manganese, or trivalent chromium; and O is oxygen; which emits radiation in the range of wave length of 3-30 microns. When B is selected to contain at least 30% of iron, it emits radiation in the wavelength range of 18 to 30 microns and the aging process is most efficient. Since the Spinel AB2O4 absorbs environmental radiation and converts it to far-infrared, it is a virtually maintenance-free source of radiation for the wine aging process of this invention.

The wrapper comprises ground spinel AB2O4 mixed with epoxy or other resins, such as ABS, PVC and a substrate which has been coated with the mixture. Said substrate may be a film, such as polyethylene, PVC or styrofoam™ in the form of two-half shells. Coating methods are known to those skilled in the art. The wrapper can be a tube, shell, or plain sheet so long it is adaptable to the shape of the wine container.

The wine aging process comprises placing the wrapper around the container. It is found that it takes only thirty minutes to age the wine.

A double blind test was made with two bottles of red wine from the same batch, one marked A and the other one B. Two sets of 12 or more wine glasses were set up, one set marked A and the other one B. One individual other than the testers performed the wrapping of one of the bottles with the wine-aging wrapper capable of emitting far-infrared radiation in the 18-30 micron spectral range for 30 minutes. Each tester tasted the wine in glass A, followed by gargling with water and expectorating. The tester then tasted the wine in the glass marked B and recorded his or her findings with respect to smell, flavor, piquantness, astringency and pleasantness

A, sample—red wine

Total testing 638 person×trial

Results of the wine testing:

| quality | improvement | No changes | deterioration |
|---|---|---|---|
| aroma | 573 (89.81%) | 65 (10.19%) | 0 |
| mellowness | 608 (95.3%) | 30 (4.7%) | 0 |
| piquantness | 602 (94.36%) | 36 (5.64%) | 0 |
| astringency | 595 (93.26%) | 43 (6.74%) | 0 |
| pleasantness | 602 (94.30%) | 36 (5.64%) | 0 |

B. Sample: White wine tested under same procedure as for the red wine

Total testing 567 person×trial

Results of white wine testing:

| quality | improvement | No changes | deterioration |
|---|---|---|---|
| aroma | 369 (65.08%) | 197 (34.74%) | 1 (0.18%) |
| mellowness | 396 (69.84)%) | 170 (29.89%) | 1 (0.18%) |
| piquantness | 388 (68.43%) | 177 (31.22%) | 2 (0.35%) |
| astringency | 391 (68.96%) | 171 (30.16%) | 5 (0.88%) |
| pleasantness | 388 (68.43%) | 179 (31.57%) | 0 |

It is concluded from the above tests that both the red wine and white wine improve their quality on aging with the method of the invention. It is believed that the esterification of organic acids reduces the acidity of the wine and improves its qualities.

We claim:

1. A wine aging wrapper comprising ground spinel AB2O4 wherein A is magnesium, divalent iron, nickel, manganese, cobalt, or zinc, B is aluminum, trivalent iron, trivalent manganese, or trivalent chromium, and O is oxygen, mixed with resin and coated on a substrate for wrapping around a wine container.

2. The wrapper of claim 1 wherein the spinel emits far-infrared radiation with a spectral range of 3-30 microns.

3. The wrapper of claim 1 wherein the spinel and resin is in the ratio of 1:3 by weight.

4. The wrapper of claim 1 wherein the resin is selected from the group consisting of epoxy, acrylonitrile-butadiene-styrene, polyvinyl chloride or any combination thereof.

5. The wrapper of claim 1 wherein the substrate is a plastic film.

6. The wrapper of claim 1 wherein the substrate is styrofoam™ in the form of two half-shells.

7. The wrapper of claim 1 wherein the spinel comprises at least of 30% of iron in B.

8. A process for aging wine comprising adapting a container of the wine to the radiation of spinel AB2O4 wherein A is magnesium, divalent iron, nickel, manganese, cobalt, or zinc, B is aluminum, trivalent iron, trivalent manganese, or trivalent chromium, and O is oxygen, said spinel radiating in the range of wavelength of 3-30 microns.

9. The process of claim 8 wherein preferred B of the spinel AB2O4 comprises at least 30% of iron.

10. The process of claim 9 wherein the spinel emits radiation in the range of 18-30 microns.

11. The process of claim 8 wherein the container is a bottle.

12. The process of claim 9 wherein the container is a wine pipeline.

13. The wrapper of claim 1 wherein the substrate is the container.

14. The wrapper of claim 7 wherein the substrate is the container.
